(19) United States
(12) Patent Application Publication
(10) Pub. No.: US 2006/0089848 A1
(43) Pub. Date: Apr. 27, 2006

(54) Political party donations from consumer goods sales

(76) Inventor: Stuart Townsend, Hollywood, FL (US)

Correspondence Address: FISH & RICHARDSON PC, P.O. BOX 1022, MINNEAPOLIS, MN, 55440-1022, US

(21) Appl. No.: 11/215,308

(22) Filed: Aug. 29, 2005

Related U.S. Application Data
(60) Provisional application No. 60/604,887, filed on Aug. 27, 2004.

(51) Int. Cl. G06Q 99/00

(52) U.S. Cl. 705/1

(57) ABSTRACT

A computer-implemented method for causing a donation to be made to a political party. The method includes receiving, from each of a plurality of consumers, order data indicative of a desired consumer transaction and a proposed donation to a political party; consummating the desired consumer transaction; on the basis of the order data, determining a donation amount for the proposed donation; for each political party, periodically determining a proposed accumulated donation amount to that political party, the accumulated donation amount being determined at least in part on the basis of proposed donations from the plurality of consumers; and consummating the proposed donations on behalf of the consumers to the extent permitted by a donation cap on accumulated donations to the political party.

### RELATED APPLICATION

Under 35 U.S.C. §119, this application claims the priority date of U.S. Provisional Patent Application Ser. No. 60/604,887, filed Aug. 27, 2004, the entire contents of which are hereby incorporated by reference.

### FIELD OF INVENTION

The present invention relates to data processing by a digital computers, and in particular to processing data representative of transactions.

### BACKGROUND

The conduct of a political campaign requires significant capital. In an effort to raise such capital, political parties expend a great deal of effort flooding constituent's mailboxes with persuasive appeals to contribute to their cause. A great many of these appeals may go unanswered because of the inconvenience associated with writing a check and the unpleasantness of entering a large debit in one's check register.

The advent of modern data processing systems has created the opportunity to introduce more painless ways of raising money. Many organizations have introduced affinity credit-cards which, when used to make a purchase, direct a portion of spent money to a particular organization. This eases the consumer's burden of making a contribution by shifting that burden to the merchant.

When using such affinity cards, the buyer selects the donee organization by selecting the affinity card to be used. It is not the case, for example, that a merchant who receives an affinity card from a consumer will ask the consumer which of several candidate donees he would like to direct his contribution to.

### SUMMARY

The invention is based on the recognition of a need to provide a way to trigger contributions to donees in a more flexible way.

The method and system disclosed herein provide a way for consumers to trigger contribution of a portion of profits to any one of a set of available donees. In cases where there exists a cap on the accumulated contributions to a donee, the method and system disclosed herein provide a way to enforce that cap, thereby greatly reducing the likelihood of running afoul of campaign finance laws.

In one aspect, the invention features a computer-implemented method to be carried out in a network of interconnected computer systems. The method includes receiving, from a consumer, an order for a consumer good; calculating a cost to fulfill the order; determining, on the basis of the cost, a donation amount to be provided to a political party; and determining whether accumulated donations made to a political party exceed a donation limit as mandated by election law.

In some practices of the invention, determining a donation amount includes determining the donation amount on the basis of expected after-tax profits. For example, determining the donation amount may include determining the donation amount to be a percentage of after-tax profits.

Alternative practices of the invention can include maintaining publicly available data indicative of donation ratios. One example of such publicly available data includes a map showing donation ratios associated with different states.

Other practices of the invention include receiving, from the consumer, information designating a political party to receive the donation.

In another aspect, the invention features a computer-implemented method for causing a donation to be made to a political party. The method includes receiving, from each of a plurality of consumers, order data indicative of a desired consumer transaction and a proposed donation to a political party; consummating the desired consumer transaction; on the basis of the order data, determining a donation amount for the proposed donation; for each political party, periodically determining a proposed accumulated donation amount to that political party, the accumulated donation amount being determined at least in part on the basis of proposed donations from the plurality of consumers; and consummating the proposed donations on behalf of the consumers to the extent permitted by a donation cap on accumulated donations to the political party.

In some practices, determining a proposed accumulated donation amount includes determining a donation amount on the basis of an anticipated after-tax profit associated with the desired consumer transaction. In other practices, it is the realized after-tax profit that is used instead of the anticipated after-tax profit.

Other practices include those in which receiving order data includes receiving order data containing information identifying a consumer good to be purchased, information identifying an outcome of an on-line auction, or data identifying a political party.

Other practices of the invention include the optional step of maintaining publicly available data indicative of donation ratios. One example of such publicly available data is a map showing donation ration associated with different states.

In another aspect, the invention features a method that includes maintaining a publicly-available web site configured to execute software for carrying out any of the foregoing computer-implemented methods.

In another aspect, the invention includes a computer-readable medium having encoded thereon software for causing a computer to execute any of the foregoing methods.

The present invention provides methods and apparatus, including computer program products, for triggering a political party donation from the sale of consumer goods.

The invention can be implemented to realize one or more of the following advantages. At least one implementation of the invention provides all of the following advantages.

Donations for political parties are raised by the sale of consumer products, with after-tax profits being used to generate such donations up to the legal limit.

A portion of the after-tax profits associated with any consumer products can be donated to a designated political party. Exemplary consumer products include wine and wine accessories, chocolate, glassware, china, gift baskets, flowers, and wine club memberships.

Orders can be taken by telephone, fax, through a designated website, mail or any other suitable ordering system. The designated web site prompts customers to register as a Republican, Democrat, Socialist, Independent, and so forth.

When orders are made, a tally is generated by state on an electoral map. States change color accordingly to represent the dominant party, with the color red representing Republican and the color blue representing Democrat, for example. Electoral votes are also tallied, but change as purchase ratios change.

Unless otherwise defined, all technical and scientific terms used herein have the same meaning as commonly understood by one of ordinary skill in the art to which this invention belongs. Although methods, hardware, and software similar or equivalent to those described herein can be used in the practice or testing of the present invention, suitable methods, hardware and software are described below. In addition, the methods, hardware, and software set forth herein are illustrative only, and are not intended to be limiting.

Other features and advantages of the invention will be apparent from the following claims, the detailed description, and the accompanying drawings, in which:

### DESCRIPTION OF THE DRAWINGS

FIG. 1 is a block diagram of computers connected by a network.

FIG. 2 is a flow diagram showing a method for triggering donations.

FIG. 3 is a block diagram of a representative architecture for software carrying out a method for triggering donations.

Like reference numbers and designations in the various drawings indicate like elements.

### DETAILED DESCRIPTION

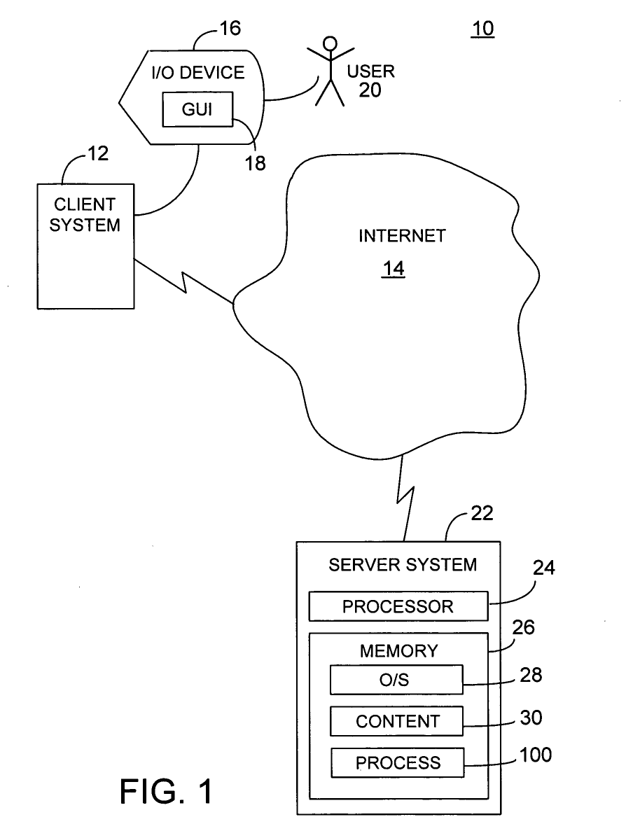

As shown in FIG. 1, an exemplary network 10 includes a client system 12 linked to a network of interconnected computer systems 14, such as the Internet. In a particular example, the network 10 is implemented as a client/server network. The client system 12 can include an input/output (I/O) device 16 for display of a graphical user interface (GUI) 18 to a consumer 20. Example GUIs include web browsers such as Mozilla, Firefox, Opera, Netscape® Navigator, and Microsoft® Internet Explorer. A web browser is an application program that provides a way to inspect and interact with information (e.g., content) on the World Wide Web (WWW). More specifically, a web browser is a client program that uses the Hypertext Transfer Protocol (HTTP) to make requests of Web servers throughout the internet on behalf of the browser user, such as consumer 20.

The network 10 includes a server system 22 linked to the network of interconnected computer systems 14. The server system 22 can include a processor 24 and memory 26. The memory 26 has stored therein portions of an operating system (OS) 28, such as Linux, Unix or Windows®, content 30, and donation software 100, which is described below. The content 30 can represent an abundant amount of subject information organized for interesting and useful access in a hypertext structure.

In a particular example, the content 30 includes a list of consumer products offered for sale and non-partisan information intended to invite individuals of different political persuasion to participate in polite discussion promoting their view point. The content 30 can also include political news and resources for consumers who are politically active or curious.

In another example, the content 30 is stored on a remote server (not shown) linked to the network of interconnected computer systems 14.

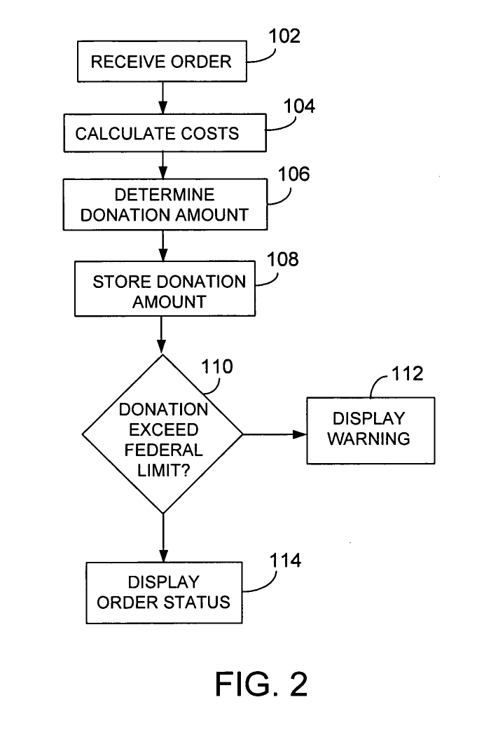

As shown in FIG. 2, the donation software 100 causes the server to receive an order for a consumer good (step 102). The order includes a consumer's name, shipping address, payment information and political party affiliation. Consumer goods can include wine and wine accessories, chocolate, glassware, china, gift baskets, flowers, wine club memberships, and so forth.

In general, what the server receives is information indicative of an economic transaction. In addition to orders for consumer goods, the information may indicate the outcome of an on-line auction, or an order for an intangible item. A wine-club membership, for example, is an intangible item. The economic transaction need not include the exchange of money, but can include the exchange of any type of consideration. For example, a wine-club membership may yield points based on prior purchase. The exchange of such points may be considered an exchange of consideration in this context.

The software 100 then causes the server to calculate a total cost to fulfill the order, including shipping, taxes, insurance, and any other ancillary costs (step 104). The software 100 then causes the server to determine a donation amount at least in part on the basis of the calculated total cost (step 106). This donation amount will be donated to the consumer's designated donee.

In some embodiments, the donee is a political party, in which case the donation amount represents a political contribution subject to certain externally imposed limits. In other cases, the donee is a lobbying organization, a political action committee, or any organization dedicated to the advancement of a particular cause. Of particular interest are donees selected from donee groups in which individual donees advance contrary positions. Such donees are of interest because the accumulated contributions for each donee can be displayed, either as a map, or as a table. These accumulated contributions then provide an informal basis for predicting the outcome of an election, or the outcome of a vote on a contested issue.

The software 100 then causes the server 22 to store the donation amount, together with a consumer's identification, such the consumer's name, and, optionally, any ancillary information concerning the consumer (step 108).

In certain cases, there exist externally imposed restrictions on donation amount. Examples of such restrictions include Federal and/or state election laws, in particular those directed at campaign finance. Thus, in certain embodiments, the software 100 causes the server 22 to determine whether accumulated donations associated with the consumer's identification exceed a maximum donation amount (step 110).

The software 100 then causes the server 22 to display, to the consumer, a warning if the consumer's donation limit exceed the maximum donation amount (step 112). Otherwise, the software 100 causes the server 22 to display, to the consumer, an order status (step 114). The order status includes estimates of order delivery date and donation amount to the designated donee, if the consumer's accumulated donations are less then the maximum donation amounts. In a particular example, twenty percent of after-tax profits associated with the sale is donated.

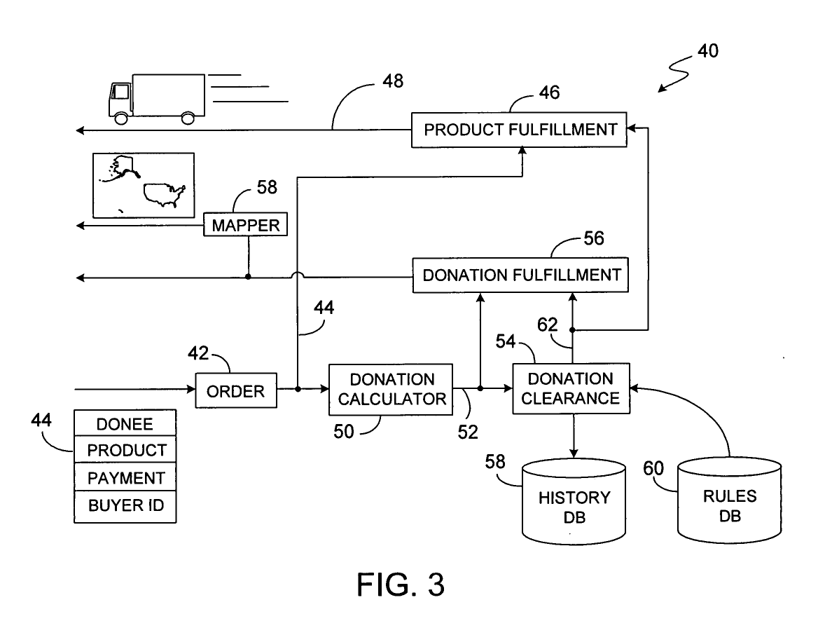

FIG. 3 illustrates a particular architecture for donation software 100 that carries out the method disclosed herein. This software 100 typically runs on the server 22, however the actual machine that carries out these instructions is not significant.

The donation software 100 includes an order process 42 that receives order data 44 from the consumer. The order data 44 includes data identifying the consumer good to be purchased, data identifying a payment source, data identifying the buyer, and data identifying a donee from a set of available donees.

The order process 42 passes the order data 44 to a product-fulfillment process 46, the output of which includes fulfillment instructions 48 for causing shipment of the identified consumer good to the designated address, and instructions to debit the appropriate amount from the payment source specified in the order data 44. However, the product-fulfillment process 46 does not release the fulfillment instructions 48 for execution immediately.

The order data 44 is also provided to a donation-calculating process 50. The donation-calculating process 50 determines the appropriate donation amount on the basis of the order amount as indicated by the order data 44. The donation-calculating process 50 provides donation data 52, which includes a proposed donation amount, and a selected donee, to both the donation-clearance process 54 and to a donation-fulfillment process 56.

The donation-fulfillment process 56 is configured to generate donation instructions that cause transfer of the appropriate donation amount from the payment source to the designated donee. However, like the product-fulfillment process 46, the donation-fulfillment process 56 does not release the donation instructions for execution immediately.

Meanwhile, the donation-clearance process 54 receives the donation data 52, and the order data 44, and retrieves, from a history database 58, information indicative of prior contributions by the buyer identified in the order data 44. To avoid the possibility that the buyer may have contributed to a political party in another context, the history database 58 is preferably dynamically linked to corresponding databases maintained by the available donees, or periodically updated by the available donees.

The donation-clearance process 54 is also in communication with a rules database 60 that contains data indicative of constraints on individual donations to various donees. These constraints typically arise from state and federal campaign finance laws. Preferably, the rules database 60 is periodically updated to remain consistent with current campaign finance laws.

The donation-clearance process 54 then determines, on the basis of the donation data 52, historical data from the history database 58 and rules data from the rules database 60, whether the proposed donation is permissible. The output of the donation-clearance process 54, which will be referred to as the donation trigger 62, includes a binary variable, together with data identifying the proposed donation. This donation trigger 62 is then provided to both the product-fulfillment process 46 and the donation-fulfillment process 56.

Both the donation-fulfillment process 56 and the product-fulfillment process 46 have been holding instructions for causing donation fulfillment and product shipment respectively. The donation trigger 62 thus acts as a trigger to cause those instructions to either be executed or discarded.

If the donation trigger 62 indicates that the proposed donation is permissible, the instructions held by the product-fulfillment process 46 and the donation-fulfillment process 56 are executed. In addition, the product-fulfillment process 46 transmits an acknowledgement to the consumer. Optionally, the donation-fulfillment process 56 updates data in a mapping process 58. Otherwise, the product-fulfillment process 46 sends an appropriate message to the consumer to report the difficulty.

The mapping process 58 maintains map data showing information derived from accumulated donations to different donees grouped by their geographical or other origin. For example, in the case of an election, the map data may show donation information associated with different electoral units (which would be states in a national election). This data is available to the public at large so that members of the public will be inclined to visit a web site to inspect the dynamically updated results. The data may also spur visitors to make a mark on the map themselves, for example by purchasing a consumer good from the web site. The data provided by the mapping process 58 also provides a basis for predicting the results of an election, as well as for providing an indication of the spatial distribution of political party support.

Example of information desired from accumulated donations include the accumulated donations themselves and ratios between accumulated donations associated with different parties. For example, the map may show the ratio between donations made to the Democratic party versus those made to the Republican party.

In another embodiment, the donation is made on behalf of a consumer 20 by a donor entity. The donor entity can be another person, a partnership, a limited liability company, or any similar organization. In that case, any caps on accumulated donation to a donee apply to the donor entity, and not to the consumer 20.

The operation of this embodiment is similar to that discussed in connection with the first embodiment, with the exception that donation fulfillment and donation clearance are carried out periodically, rather than on demand, or on a per transaction basis.

In this embodiment, when order data 44 includes an instruction to make a donation to a particular donee, the donation-calculating process 50 updates an accumulated donation to that donee in the history database 58. The accumulated donation to that donee represents the aggregate of all donations intended for that donee, regardless of the identity of the consumer 20.

Periodically, for example at the end of an accounting cycle, the donation-clearance process 54 inspects the accumulated donation from the history database 58 and retrieves rules data from the rules database 60. The donation-clearance process 54 then determines, on the basis of the retrieved rules data, whether or not the accumulated donation is less than a donation cap associated with that donee.

If the accumulated donation is less than the donation cap, the donation-clearance process 54 causes the donation-fulfillment process 56 to transmit instructions for donating the accumulated donation. Otherwise, the donation-clearance process 54 causes the donation-fulfillment process 56 to transmit instructions for donating an amount equal to the cap. Any residual amount in the accumulated donation can then be carried over for the following accounting cycle or transferred to a retained earnings account.

Although the donation cap is typically specified on an annual basis, it is not necessary for donation fulfillment to occur only on an annual basis. For example, one might attempt to predict what the accumulated amount will be at the end of a one year period on the basis of an accumulated amount to date, and execute donation fulfillment accordingly. One method for doing so includes creating monthly caps, each of which is 1/12 of an annual cap, and making a donation every month, but only to the extent of the monthly cap.

Or one might execute the donation-fulfillment process 56 monthly to donate whatever has been donated that month, until a cap for the year is reached, at which point the periodic execution of the donation-fulfillment process 56 stops until the accumulated amount can be reset to zero at the end of the year.

In an embodiment in which donations are made periodically rather than on demand, it is possible to also evaluate the donation amount periodically. For example, the order data 44 specifies a donation amount that is, for example, 20% of after-tax profits, it may be useful to determine the after-tax profit associated with a period that has already lapsed. This avoids the risk associated with estimating an after-tax profit for a period when earnings and expenses for that period have yet to be realized.

In an optional practice of the disclosed method, the donation-calculating process 50 is executed periodically, rather than on demand. In such a case, the donation amount is not known at the time the consumer makes the purchase. Instead the donation amount, which depends on after-tax profits, is determined later, when after-tax profits can be determined with certainty.

In this embodiment, the donation-calculating process 50 imports accounting information from an accounting process (not shown) and retrieves a history of purchases from the history database 58. Then, the donation-calculating process 50 computes a donation amount for each donee and provides that amount to the donation-clearance process 54, which proceeds as described above.

A variety of other accounting methods can be used to determine donation amounts and the timing of donations.

Embodiments of the invention can be implemented in digital electronic circuitry, or in computer hardware, firmware, software, or in combinations thereof. Embodiments of the invention can be also implemented as a computer program product, i.e., a computer program tangibly embodied in an information carrier, such as a machine-readable storage device, or tangibly embodied as a propagated signal, for execution by, or to control the operation of, a data processing apparatus. An exemplary data processing apparatus can include a programmable processor, a computer, or multiple computers.

A computer program can be written in any form of programming language, including compiled or interpreted languages, and can be deployed in any form, including as a stand-alone program, or as a module, component, subroutine, or other unit suitable for use in a computing environment. A computer program can be deployed for execution on one computer, or on multiple computers. In the latter case, the multiple computers can be at one site, or distributed across multiple sites and interconnected by a communication network.

The method steps described herein can be performed by one or more programmable processors executing a computer program that operates on input data and generates output. Method steps can also be performed by, and the apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. Such computers often include a processor for executing instructions, and one or more memory devices for storing instructions and data. Generally, a computer will also include, or be operatively coupled to receive data from or transfer data to, or both, one or more mass-storage devices for storing data, e.g., magnetic, magneto-optical disks, or optical disks. Information carriers suitable for embodying computer-program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

It is to be understood that the foregoing description is intended to illustrate and not to limit the scope of the invention, which is defined by the scope of the appended claims. For example, a consumer's order can be received by telephone or facsimile and entered into the server system by an administrator. Order confirmation can be sent to the consumer by regular paper mail. Other embodiments are within the scope of the following claims.

It is also to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

Having described the invention, and a preferred embodiment thereof, what is claimed as new and secured by Letters Patent is:

1. A computer-implemented method comprising:
in a network of interconnected computer systems, receiving, from a consumer, an order for a consumer good;
calculating a cost to fulfill the order;
determining, on the basis of the cost, a donation amount to be provided to a political party; and
determining whether accumulated donations to a political party exceed a donation limit as mandated by election law.

2. The method of claim 1, wherein determining a donation amount comprises determining the donation amount on the basis of expected after-tax profits.

3. The method of claim 2, wherein determining the donation amount comprises determining the donation amount to be a percentage of after-tax profits.

4. The method of claim 1, further comprising maintaining publicly available data indicative of donation ratios.

5. The method of claim 4, wherein maintaining publicly available data comprises providing a map showing donation ratios associated with states.

6. The method of claim 1, further comprising receiving, from the consumer, information designating a political party to receive the donation.

7. A computer-implemented method for causing a donation to be made to a political party, the method comprising:
receiving, from each of a plurality of consumers, order data indicative of a desired consumer transaction and a proposed donation to a political party;
consummating the desired consumer transaction;
on the basis of the order data, determining a donation amount for the proposed donation;
for each political party, periodically determining a proposed accumulated donation amount to that political party, the accumulated donation amount being determined at least in part on the basis of proposed donations from the plurality of consumers; and
consummating the proposed donations on behalf of the consumers to the extent permitted by a donation cap on accumulated donations to the political party.

8. The method of claim 7, wherein determining a proposed accumulated donation amount comprises determining a donation amount on the basis of an anticipated after-tax profit associated with the desired consumer transaction.

9. The method of claim 7, wherein determining a proposed accumulated donation amount comprises determining a donation amount on the basis of a realized after-tax profit associated with the desired consumer transaction.

10. The method of claim 7, wherein receiving order data comprises receiving order data containing information identifying a consumer good to be purchased.

11. The method of claim 7, wherein receiving order data comprises receiving order data containing information identifying an outcome of an on-line auction.

12. The method of claim 7, further comprising maintaining publicly available data indicative of donation ratios.

13. The method of claim 12, wherein maintaining publicly available data comprises maintaining a map showing donation ratios associated with different states.

14. A method comprising maintaining a publicly-available web site configured to execute software for carrying out the computer-implemented method recited in claim 7.

15. A computer-readable medium having encoded thereon software for causing a computer to execute the method recited in claim 7.

16. A method comprising maintaining a publicly-available web site configured to execute software for carrying out the computer-implemented method recited in claim 1.

17. A computer-readable medium having encoded thereon software for causing a computer to execute the method recited in claim 1.

18. A computer-implemented method for causing a donation to be made to a donee, the method comprising:
receiving, from a consumer, order data indicative of a desired consumer transaction and a proposed donation to a donee selected from a set of donees;
consummating the desired consumer transaction;
on the basis of the order data, determining a donation amount for the proposed donation;
for each donee in the set, periodically determining a proposed accumulated donation amount to that donee, the accumulated donation representing an aggregate of all donations proposed for that donee by consumers; and
consummating the proposed donation on behalf of the consumers.
